(19) United States
(12) Patent Application Publication
(10) Pub. No.: US 2019/0293408 A1
(43) Pub. Date: Sep. 26, 2019

(54) OPTICAL MODULE FOR OPTICAL HEIGHT MEASUREMENT

(71) Applicant: Hitachi-LG Data Storage, Inc., Tokyo (JP)

(72) Inventors: Daisuke TOMITA, Tokyo (JP); Hideo SUENAGA, Tokyo (JP); Takahiro KUROKAWA, Tokyo (JP); Yoshitaka MORIMOTO, Tokyo (JP)

(21) Appl. No.: 16/170,079

(22) Filed: Oct. 25, 2018

(30) Foreign Application Priority Data
Mar. 23, 2018 (JP) 2018-055894

(51) Int. Cl. G01B 11/06

(52) U.S. Cl. CPC G01B 11/0608

(57) ABSTRACT

An optical module for optical height measurement optically measures a height of a specimen and includes an irradiation optical system, two detection optical systems, and a light dividing element. The irradiation optical system includes a laser light source and an objective lens to irradiate the specimen with a light beam. The two detection optical systems each include a divided optical detector configured to detect a reflected light reflected by the specimen. The light dividing element is configured to guide the reflected light to the two detection optical systems. A light that has transmitted the light dividing element and a light reflected by the light dividing element are guided to the respective two detection optical systems. Intensity distributions of the transmitted light and the reflected light on the two detection optical systems are inverted in line symmetry.

### CROSS-REFERENCE TO RELATED APPLICATION

The present application claims priority from Japanese application JP 2018-055894, filed on Mar. 23, 2018, the contents of which is hereby incorporated by reference into this application.

### BACKGROUND

The present invention relates to an optical module for optical height measurement that optically measures a height of a specimen.

There has been known a focus control signal used for an optical disk device that is used to highly accurately focus a disk as a specimen. Japanese Patent Application Laid-Open No. 9-265722 discloses a state in which the focus control signal changes according to a change in shift amount of a focal position to the specimen.

While in Japanese Patent Application Laid-Open No. 9-265722, a light reflected by a specimen is guided to an optical detector by an objective lens and an objective lens group, generally, the objective lens group includes, for example, collimator lenses and cylindrical lenses, and the optical detector is achieved by the use of a four-divided detector. The cylindrical lens allows adding an astigmatism to the light. When a height of the specimen changes, a spot shape on the optical detector changes into an ellipsoid. Operating a signal change from the optical detector ensures generating a focus error signal correlated to a distance with the specimen.

However, in the case where the shape of the specimen is not an approximately flat surface like a disk but the specimen has, for example, a part having a curvature, a reflection angle changes depending on the position of the light with which the specimen is irradiated and a part of the light guided to a light receiving element does not return, possibly failing to generate the normal focus error signal.

### SUMMARY OF THE INVENTION

An object of the present invention is to provide an optical module for optical height measurement that generates a signal correlated to a distance with a specimen having any shape and allows highly accurately detecting the distance with the specimen.

In consideration of the above-described background art and object, one example of the present invention is an optical module for optical height measurement that optically measures a height of a specimen and includes an irradiation optical system, two detection optical systems, and a light dividing element. The irradiation optical system includes a laser light source and an objective lens to irradiate the specimen with a light beam. The two detection optical systems each include a divided optical detector configured to detect a reflected light reflected by the specimen. The light dividing element is configured to guide the reflected light to the two detection optical systems. A light that has transmitted the light dividing element and a light reflected by the light dividing element are guided to the respective two detection optical systems. Intensity distributions of the transmitted light and the reflected light on the two detection optical systems are inverted in line symmetry.

The present invention can provide an optical module for optical height measurement that can highly accurately detect a height of a specimen having any shape.

### BRIEF DESCRIPTION OF THE DRAWINGS

FIGS. 1(a)-1(d) are conceptual diagrams describing a principle of optically measuring a height of a specimen in an example;

FIGS. 2(a)-2(c) are explanatory views of a reflected light when a surface of the specimen is not a flat surface in the example;

FIGS. 3(a)-3(b) are explanatory views regarding a cause for an increase in height error due to a shift of an irradiation position by a light beam from an axis center of a curved surface in the example;

FIGS. 4(a)-4(c) are explanatory views for explaining the problems of optical systems that measure the height of the specimen by an astigmatism method in the example;

FIGS. 5(a)-5(c) are explanatory views of the optical systems that measure the height of the specimen by the astigmatism method in the example; and

FIG. 6 is a detailed configuration diagram of the optical systems that measure the height of the specimen by the astigmatism method in the example.

### DETAILED DESCRIPTION OF THE PREFERRED EMBODIMENTS

The following describes an example of the present invention with reference to the drawings.

### Example

This example describes an optical module for optical height measurement that can highly accurately detect a height of a specimen having any shape when the specimen does not have a flat surface.

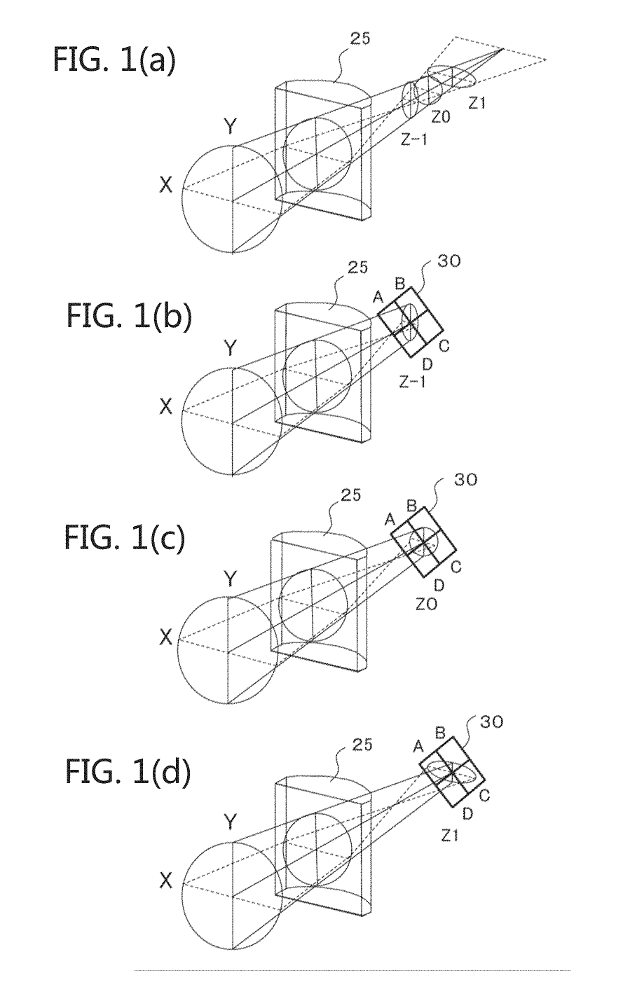

First, the following describes a principle of optically measuring the height of the specimen. FIGS. 1(a) to 1(d) are conceptual diagrams describing a method that irradiates the specimen with a light beam and measures the height of the specimen from the reflected light using an astigmatism method. In FIG. 1(a), in the astigmatism method, generally, when a cylindrical lens 25 is used, and the cylindrical lens 25 is inserted in an optical path of the reflected light of the light beam with which the specimen is irradiated by an objective lens reflected by the specimen, since the cylindrical lens 25 has a lens effect only in an X-axis direction of FIG. 1(a), a focal distance in the X-axis direction is shifted from a focal distance in a Y-axis direction and this generates an astigmatism. The shape of the beam changes like a vertically long ellipse (Z-1), a circular shape (Z0), and a horizontally long ellipse (Z1) according to the distance on the optical axis. Here, as illustrated in FIGS. 1(b), 1(c), and 1(d), when the light beam is received by an optical detector 30, which is installed being inclined by 45 degrees with respect to the cylindrical axis (the Y-axis direction) of the cylindrical lens 25 and divided into four, A to D, a balance of an amount of incident light between A to D changes in respective cases Z-1, Z0, and Z1. In the case of FIG. 1(b), the amounts of incident light of B and D are large, in the case of FIG. 1(c), the four amounts of incident light of A to D are equal, or in the case of FIG. 1(d), the amounts of incident light of A and C are large. Accordingly, for example, a distance between the specimen and the objective lens and the cylindrical lens 25 in the state where the four amounts of incident light of A to D are equal like FIG. 1(c) is set as a predetermined reference surface, and the height of the specimen can be measured from a value of a result of an arithmetic operation (hereinafter referred to as a focus error signal (an FE signal) of (A+C)−(B+D). That is, when the reflection surface of the specimen is lower than the reference surface, the state becomes like FIG. 1(d) and the FE signal>0. When the reflection surface of the specimen is higher than the reference surface, the state becomes like FIG. 1(b) and the FE signal<0. The measurement of the FE signal allows measuring the height of the specimen from a difference with the reference surface.

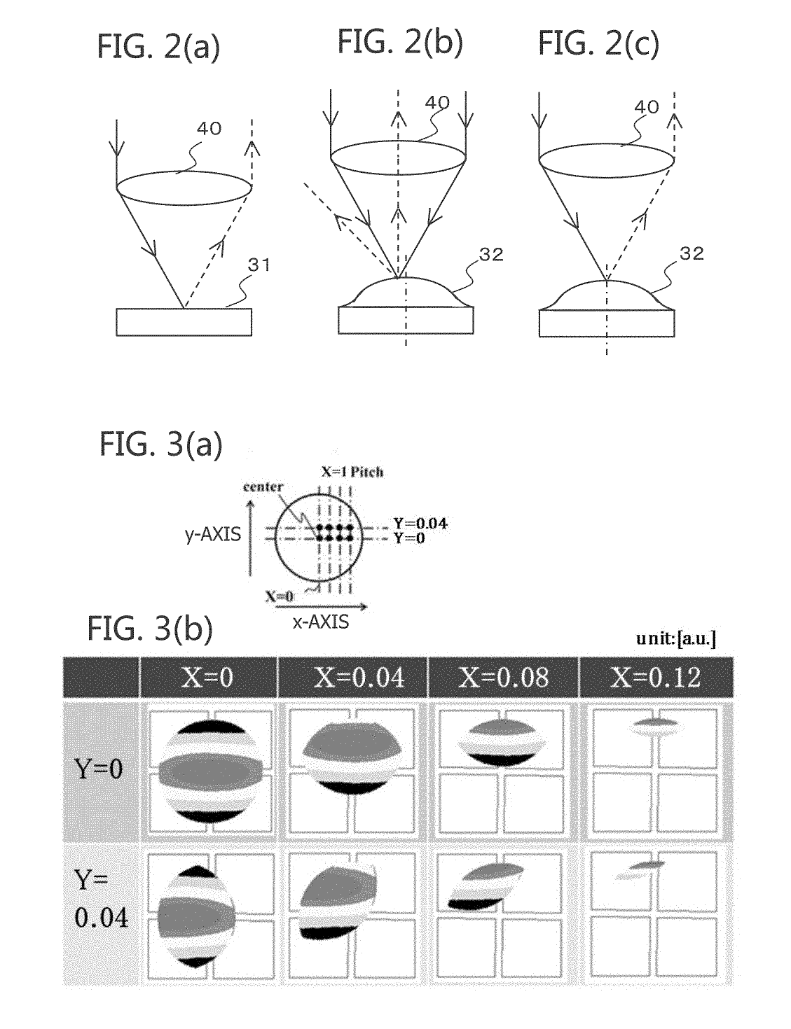

Next, the following describes the reflected light when the surface of the specimen is not a flat surface. FIG. 2(a)-FIG. 2(c) are schematic diagrams illustrating a state where a reflected light changes according to the shape of the surface of the specimen. In order to irradiate the specimen with the light and measure the height of the specimen using the reflected light, when the surface of the specimen of FIG. 2(a) is a flat surface 31, an incident light of an objective lens 40 is reflected by the specimen and returns to the objective lens 40; therefore, the amount of light at an aperture of the objective lens 40 does not change. In contrast to this, as illustrated in FIGS. 2(b) and 2(c), when the surface of the specimen is, for example, a curved surface 32, as illustrated in FIG. 2(b), irradiating a position other than an apex of the curved surface 32 with a light beam changes a reflection angle of the light. This causes a partially lacked part due to the aperture of the objective lens 40 and therefore fails to stably obtain the reflected light, causing a problem of failing to accurately measure the height. As illustrated in FIG. 2(c), as long as the irradiation position by the light beam is the apex (the highest point of the specimen) of the curved surface 32, the incident light of the objective lens 40 is reflected by the specimen and returns to the objective lens 40; therefore, similarly to the case of the flat surface, the amount of light at the aperture of the objective lens 40 does not change. That is, to irradiate the specimen whose surface is not the flat surface with the light beam to measure the height of the specimen from the reflected light using the astigmatism method, when the irradiation position by the light beam is shifted from the apex of the specimen, the reflected light cannot be stably obtained and waveforms of the FE signal are collapsed, causing a problem of increase in height error.

Here, a cause of the increase in height error due to the shift of the irradiation position by the light beam from the axis center of the curved surface when the surface of the specimen is the curved surface is examined.

For example, FIG. 3(b) illustrates light spots on the optical detector by the astigmatism method when the surface of the specimen as the surface having the curvature is irradiated with the light beam shifted from the center position of the curved surface in an XY direction as illustrated in FIG. 3(a). FIG. 3(b) illustrates the light spots on the optical detector when the irradiation position by the light beam is scanned from the center of the curved surface X=0 and Y=0 to 0, 0.04, 0.08 and 0.12 in the X-direction with Y=0, and when the irradiation position by the light beam is scanned to 0, 0.04, 0.08, and 0.12 in the X-direction with Y=0.04. The shift amount in the XY direction is a normalized value of the shift amount of the spot by a radius of the curvature that the specimen surface has. It has been found from FIG. 3(b) that, as being shifted in the X-direction from the center, a balance of an intensity distribution of the light spot on a four-divided optical detector is lost due to a lack of a part of a feedback light caused by the shift of the irradiation position by the light beam from the axis center of the curved surface. Further, the shift in the Y-direction increases the trend. When the irradiation position is shifted from the center in the Y-direction, an amount of received light is biased to one element on the four-divided detector and the value of the FE signal largely changes, generating a height deviation.

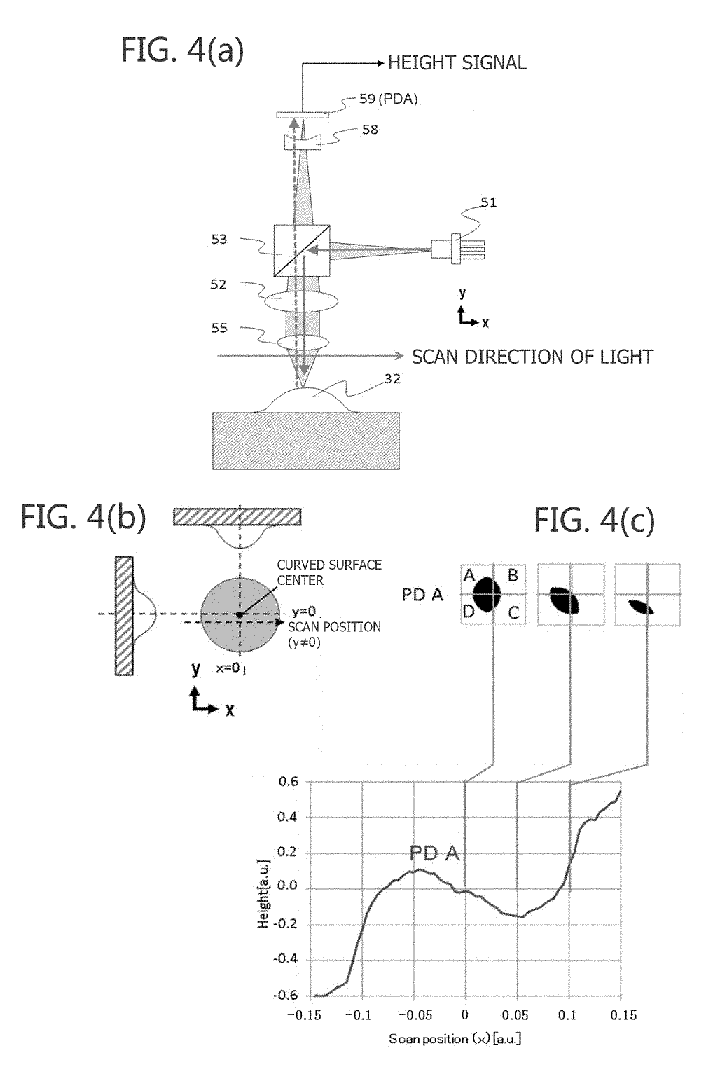

FIGS. 4(a)-4(c) illustrate the above-described problems. FIGS. 4(a) and 4(b) show a schematic configuration diagram of optical systems that measure the height of the specimen by the astigmatism method. In FIG. 4(a), the light beam emitted from a laser light source 51 is reflected by a beam splitter 53, transformed into a parallel light by a collimator lens 52, and condensed by an objective lens 55. Thus, the curved surface 32 as specimen is irradiated with the light beam by an irradiation optical system, which includes the laser light source 51, the beam splitter 53, and the collimator lens 52. The reflected light reflected by the curved surface 32 transmits the beam splitter 53 and is guided to a cylindrical lens 58 and a four-divided optical detector 59(PDA), which are included in a detection optical system.

Here, when these optical systems are scanned in the X-direction in the diagram, a relationship between a position in the X-direction when the optical systems are scanned in the X-direction at a position shifted from the center of the curved surface 32 in the Y-direction and a height signal Sh of the following Formula (1) found by normalizing the FE signal obtained from the four-divided optical detector 59(PDA) by a sum signal of the four-divided optical detector becomes as illustrated in FIG. 4(c).

[Formula 1]

Sh=((A+C)−(B+D))/(A+B+C+D) (1)

That is, as illustrated in FIG. 4(c), due to the shift of the irradiation position by the light beam from the axis center of the curved surface, the balance of the intensity distribution of the light spot on the four-divided optical detector is lost, generating the height error.

Therefore, to lower losing the balance of the intensity distribution of the light spot on the four-divided optical detector, this example includes two detection optical systems by the optical detectors such that the respective detection optical systems work so as to cancel losing the balance on the four-divided optical detector.

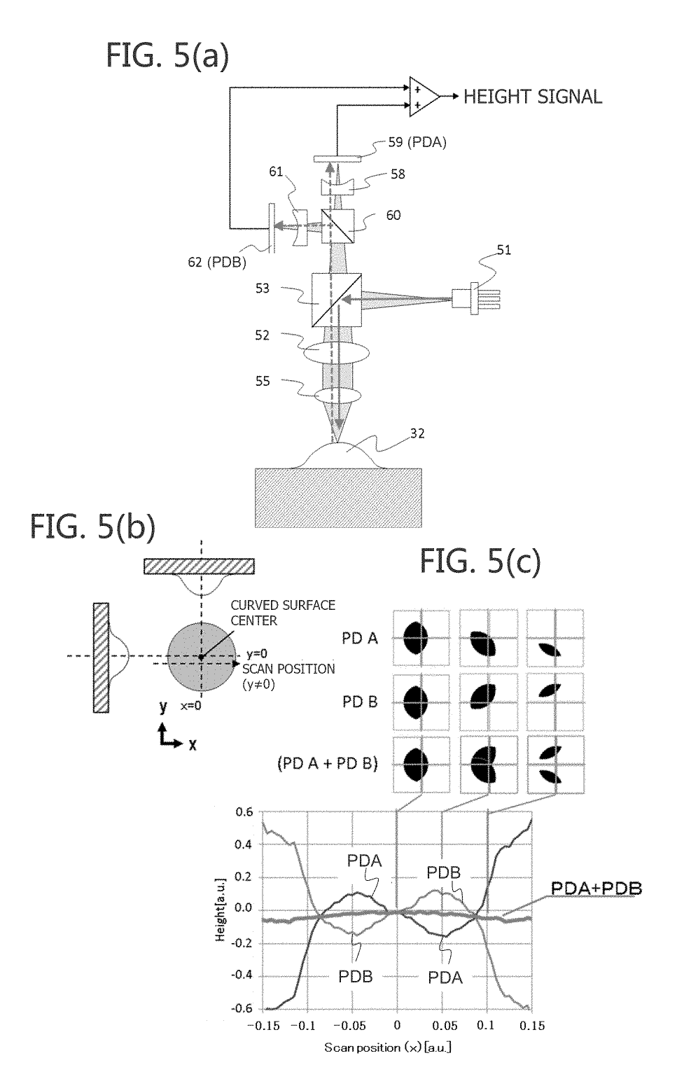

FIGS. 5(a) and 5(b) show a schematic configuration diagram of the optical systems that measure the height of the specimen by the astigmatism method in this example. In FIG. 5(a), identical reference numerals are assigned for the configurations identical to those of FIG. 4(a) and the descriptions are omitted. The difference from FIG. 4(a) is that a half beam splitter 60, a cylindrical lens 61, and a four-divided optical detector 62(PDB) are disposed.

In FIG. 5(a), the half of the reflected light reflected by the curved surface 32 from the beam splitter 53 transmits the half beam splitter 60 as a light dividing element and is guided to the cylindrical lens 58 and the four-divided optical detector 59(PDA). The remaining half of the light is reflected and is guided to the cylindrical lens 61 and the four-divided optical detector 62(PDB). Here, the light beam guided to the four-divided optical detector 62(PDB) is reflected by the half beam splitter 60; therefore, the light beam is configured to be inverted from the light beam guided to the four-divided optical detector 59(PDA). Here, when these optical systems are scanned in the X-direction in the diagram, FIG. 5(c) illustrates a relationship between a position in the X-direction when the optical systems are scanned in the X-direction at a position shifted from the center of the curved surface 32 in the Y-direction and the height signals Sh obtained from the respective four-divided optical detector 59(PDA) and four-divided optical detector 62(PDB).

As illustrated in FIG. 5(c), due to the shift of the irradiation position by the light beam from the axis center of the curved surface, the balance of the intensity distribution of the light spot is lost on the four-divided optical detectors, which are the respective four-divided optical detector 59(PDA) and four-divided optical detector 62(PDB), and thus the height error is generated; however, the height signals obtained from the respective four-divided optical detectors become approximately line symmetry. Therefore, adding the respective height signals can lower the height error. That is, it is only necessary to use a height signal Shd found from the following Formula (2).

$$\begin{matrix}[ Formula 2 ] & \\ Shd = \{ \frac{( {A}_{PDA} + {C}_{PDA} ) - ( {B}_{PDA} + {D}_{PDA} )}{{A}_{PDA} + {B}_{PDA} + {C}_{PDA} + {D}_{PDA}} + \frac{( {A}_{PDB} + {C}_{PDB} ) - ( {B}_{PDB} + {D}_{PDB} )}{{A}_{PDB} + {B}_{PDB} + {C}_{PDB} + {D}_{PDB}} \} \div 2 & ( 2 )\end{matrix}$$

Note that the suffix PDA indicates an output from the four-divided optical detector 59(PDA) and the suffix PDB indicates an output from the four-divided optical detector 62(PDB).

In view of this, as indicated by PDA+PDB, the addition of the height signals of PDA and PDB, of FIG. 5(c), the height error caused by the shift of the irradiation position by the light beam from the axis center of the curved surface can be lowered.

As illustrated in FIG. 5(c), regarding the light spots on the respective optical detectors of the four-divided optical detector 59(PDA) and four-divided optical detector 62(PDB), the balances of the intensity distributions of the light spots on the four-divided optical detectors are lost and biased on the respective four-divided optical detector 59(PDA) and four-divided optical detector 62(PDB) due to the shift of the irradiation position by the light beam from the axis center of the curved surface. However, since the intensity distributions of the light spots on the respective four-divided optical detectors are inverted in line symmetry, the losses of the balances of the intensity distributions of the light spots on the optical detectors can be canceled through the operation.

Thus disposing the two detection optical systems allows obtaining the good height signal by which the center axis can be found.

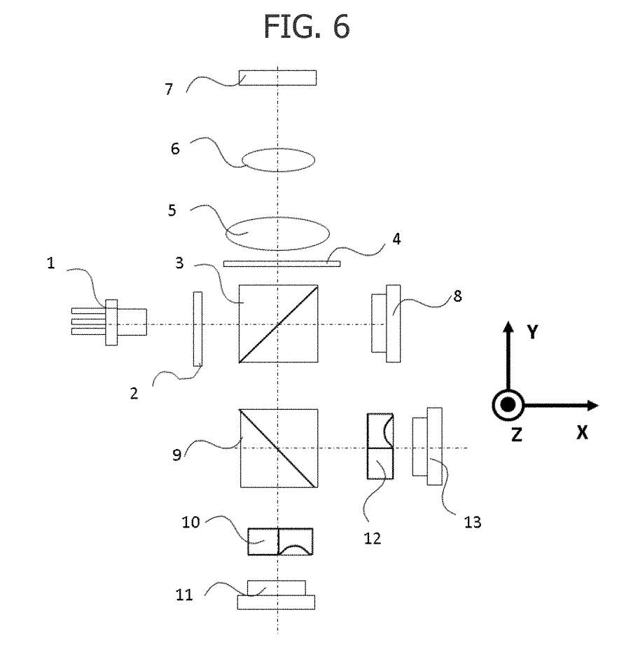

FIG. 6 illustrates a detailed configuration diagram of the optical systems of this example that measure the height of the specimen by the astigmatism method illustrated in FIGS. 5(a)-5(b). In FIG. 6, a polarization state of the light beam emitted from a laser light source 1 is polarized to an S-polarized light with a λ/2 plate 2, the light beam is reflected by a polarization beam splitter 3, the polarization state is transformed from the S-polarized light to a circular polarized light with a λ/4 plate 4, the light beam is transformed into a parallel light by a collimator lens 5 and condensed by an objective lens 6, and a specimen 7 is irradiated with the light beam. The polarization state of the reflected light reflected by the specimen 7 is transformed from the circular polarized light into a P-polarized light with the λ/4 plate 4, and the reflected light transmits the polarization beam splitter 3 and enters a half beam splitter 9 as a light dividing element. The half of reflected light reflected by the specimen 7 with the half beam splitter 9 is guided to a cylindrical lens 12 whose cylindrical axis is inclined by 45° around the X-axis and a four-divided optical detector 13. At this time, the four-divided optical detector 13 is installed in a direction inclined by 45° with respect to the cylindrical axis of the cylindrical lens 12, and a division line of the four-divided optical detector 13 is positioned in a horizontal-vertical direction (a horizontal direction Y and a vertical direction Z). The half of the reflected light entered to the half beam splitter 9 transmits a cylindrical lens 10 whose cylindrical axis is inclined by 45° around the Y-axis and is guided to a four-divided optical detector 11. At this time, the cylindrical lens 10 is inclined in an identical direction and at an identical degree with the cylindrical lens 12 around the optical axis. Additionally, the four-divided optical detector 11 is installed in a direction inclined by 45° with respect to the cylindrical axis of the cylindrical lens 10, and the division line of the four-divided optical detector 11 is positioned in the horizontal-vertical direction (the horizontal direction X and the vertical direction Z). Here, since the light beam guided to the four-divided optical detector 13 is reflected by the half beam splitter 9, the light beam is inverted from the light beam guided to the four-divided optical detector 11 in line symmetry. That is, the intensity distributions of the light spots are inverted in line symmetry between the four-divided optical detectors 11 and 13. Accordingly, the four-divided optical detectors work so as to cancel the losses of the balances of the intensity distributions of the light spots on the respective four-divided optical detectors. Note that a front monitor 8 is a detector used for power control of the laser light source 1. As long as light efficiency is permitted, the polarization beam splitter 3 may be a half beam splitter. In this case, the λ/2 plate 2 and the λ/4 plate 4 may be eliminated. The shape of light receiving portions of the optical detectors is a square shape and may be subdivided into four divisions or more. The cylindrical lens 12 and the cylindrical lens 10 only need to be inclined in the identical direction and at the identical degree around the optical axis, and the four-divided optical detector 13 and the four-divided optical detector 11 only need to be installed to be inclined by 45° with respect to the cylindrical axes of the cylindrical lenses, which guide the lights to the respective four-divided detectors.

Thus, with this example, the detection optical systems by the optical detectors are disposed by two and the respective detection optical systems work so as to cancel the losses of the balances of the intensity distributions of the light spots on the optical detectors.

This allows providing the optical module for optical height measurement that can highly accurately detect the height of the specimen having any shape.

While the example has been described above, the present invention is not limited to the above-described example and includes various modifications. For example, while the example describes the optical system using the polarization beam splitter, a half beam splitter is also effective. While the example describes the astigmatism method as the detection optical systems, other FE signal detection methods, for example, a knife-edge method is also effective. Additionally, the above-described example has been described in detail for ease of understanding of the present invention; therefore, the example is not necessarily limited to the one that includes all configuration described above.

What is claimed is:

1. An optical module for optical height measurement that optically measures a height of a specimen, comprising:
an irradiation optical system that includes a laser light source and an objective lens to irradiate the specimen with a light beam;
two detection optical systems that each include a divided optical detector configured to detect a reflected light reflected by the specimen; and
a light dividing element configured to guide the reflected light to the two detection optical systems,
wherein a light that has transmitted the light dividing element and a light reflected by the light dividing element are guided to the respective two detection optical systems, and intensity distributions of the transmitted light and the reflected light on the two detection optical systems are inverted in line symmetry.

2. The optical module for optical height measurement according to claim 1, wherein the two detection optical systems are configured to detect focus error signals using an astigmatism.

3. The optical module for optical height measurement according to claim 1, wherein the divided optical detectors include the respective light receiving elements having a square shape and are divided into at least four or more.

4. The optical module for optical height measurement according to claim 1, wherein the light dividing element includes a half beam splitter.

5. The optical module for optical height measurement according to claim 1, wherein the two detection optical systems each have a cylindrical lens and a four-divided optical detector, the two detection optical systems being configured to add respective values found by normalizing focus error signals using an astigmatism by a sum signal of the four-divided optical detectors to detect a height signal.
